(19) United States
(12) Patent Application Publication
(10) Pub. No.: US 2004/0048541 A1
(43) Pub. Date: Mar. 11, 2004

(54) Composite fibrous substrates having carbohydrate sheaths

(75) Inventors: David A. Offord, Castro Valley, CA (US); William Ware JR., Oakland, CA (US); Dan B. Millward, Alameda, CA (US); David S. Soane, Piedmont, CA (US); Manfred A. Young, Greensboro, NC (US)

Correspondence Address: JACQUELINE S LARSON, P O BOX 2426, SANTA CLARA, CA, 95055-2426, US

(73) Assignee: Nano-Tex, LLC

(21) Appl. No.: 10/624,095

(22) Filed: Jul. 21, 2003

Related U.S. Application Data
(63) Continuation of application No. PCT/US02/02091, filed on Jan. 24, 2002.
(63) Continuation-in-part of application No. 10/059,657, filed on Jan. 29, 2002, now Pat. No. 6,617,267.
Application No. 10/059,657 is a division of application No. 09/274,749, filed on Mar. 23, 1999, now Pat. No. 6,379,753.
(60) Provisional application No. 60/264,181, filed on Jan. 25, 2001.
(60) Provisional application No. 60/316,358, filed on Aug. 30, 2001.

(51) Int. Cl. B32B 19/00; D04H 1/00; D04H 3/00

(52) U.S. Cl. 442/364; 427/434.2; 442/414; 428/357; 428/378

(57) ABSTRACT

The present invention is directed to a method for treating a synthetic, man-made, or natural fiber substrate to create a permanently attached carbohydrate sheath around the fibers of the substrate. Such a treatment gives a composite fibrous substrate that exhibits the most desirable characteristics of the fiber core coupled with the most desirable characteristics of the carbohydrate sheath. It is also possible to apply this technology to individual synthetic fibers or yarns, if desired, before weaving, knitting, stitch-bonding or other method of woven or non-woven substrate formation.

This application is a continuation of co-pending International Application No. PCT/U.S.02/02091, filed on Jan. 24, 2002 and designating the United States of America, which application claims benefit of U.S. provisional applications 60/316,358, filed Aug. 30, 2001, and No. 60/264,181, filed Jan. 25, 2001; the entire disclosures of all of which applications are incorporated herein by reference.

### BACKGROUND OF THE INVENTION

The use of synthetic fabrics and blends by consumers has decreased over recent years in favor of 100% cotton fabrics which offer preferred appearance and comfort; especially in apparel. However, the use of 100% cotton yarn and fabrics has disadvantages, including a tendency to shrink and wrinkle. The most popular method of controlling cotton shrinkage and wrinkling for apparel outerwear is to crosslink the cotton fiber with formaldehyde-based resins. However, formaldehyde is considered to be a hazardous chemical and dangerous to handle during processing. It is also considered dangerous on fabrics that come into contact with the body because formaldehyde is a known carcinogen. Additionally, formaldehyde-based resins, when used to control the shrinkage and wrinkling of cotton or cotton blend fabrics, degrade the abrasion resistance and strength properties of the fabric and make them more prone to abrasion, wear, formation of fabric holes and scuffing. Although non-formaldehyde resins have been invented (e.g., polycarboxylic acids), they are less effective, more expensive, and equally prone to fabric strength loss.

Pre-washing fabric in the textile mill to control shrinkage is also unsatisfactory because it wastes energy and gives new garments a worn appearance. Mechanical compaction has been used to control the shrinkage of cotton fabrics. However, this process is expensive because of the high working loss and is not a permanent solution as compacted garments tend to return to their pre-compacted dimensions. Also, neither of these methods addresses the wrinkling tendency of cotton. For these reasons, the treating of cotton by resin is the currently preferred method to control the shrinkage and wrinkling of cotton fabrics.

With the advent of hydrophobic synthetic textile fibers (e.g. polyester, polyacrylamide, polyolefin, polyacrylate, nylon, and the like), continuous filament yarns became available, which have greater strength and more durability than staple fibers, and with fewer wrinkling or shrinkage problems. The shrinkage of fabrics made of these fibers can be controlled by using a yarn where the heat annealing point of the synthetic fiber polymer has been exceeded. Products made from synthetic yarn have excellent strength properties, dimensional stability and good color fastness to washing, dry-cleaning, and light exposure. The use of 100% polyester knit and woven fabrics became extremely popular during the late 1960's and through the 1970's. More recently, continuous filament polyester fiber has also been cut into staple that can then be spun into 100% staple yarns or blended with cotton or other natural fibers. However, synthetic yarns and fabric made from these yarns have many undesirable properties, including a shiny, synthetic appearance, a slick, artificial tactile “feel”, limited moisture transport ability, and a tendency to accumulate static charge. Additionally, polyester fiber is prone to pilling in staple form and picking in continuous filament form.

Several attempts have been made to produce fabrics which combine only the positive qualities of both cotton and synthetic fibers. Such attempts have included blending, sheath/core yarn spinning, and sheath/core fiber composites (grafting). These methods require modifications of the fibers, and cannot satisfactorily be performed on fabrics.

Conventional methods of blending cotton and synthetics together have been less than fully successful as both mechanical and intimate blends of polyester and cotton tend to pill, pick, and shrink, may be subject to static accumulation, and can be uncomfortable to wear. The consumer's use of polyester and polyester blended fabrics has declined over recent years in favor of 100% cotton fabrics, which offer preferred appearance and comfort.

Yarns have been manufactured for many years with a distinct natural fiber sheath/synthetic fiber core configuration. (U.S. Pat. Nos. 4,711,079; 5,497,608; 5,568,719; and 5,618,479). A well-known method of spinning both homogenous and composite yarns is ring spinning, which produces a strong yarn of high quality, with a low capital investment per spindle. However, ring spinning is a comparatively slow process that produces only about 10 to 25 meters of yarn per minute, which greatly increases the cost of the final product. Moreover, control over placement of the natural fibers is poor; the resulting yarn has an uneven distribution of sheath fibers over the core including sections without any sheath content. Still, since no other previously known process can produce the strength or feel of ring-spun yarn, this process is used when the demand for the yarn's strength and feel justifies its high cost.

The concept of producing sheath/core fiber composites by grafting or co-extrusion is a relatively new attempt to solve this problem (U.S. Pat. Nos. 3,824,146; 5,009,954; 5,272,005; 5,387,383). In this process, a synthetic core fiber is passed through a fiber-coating die where it contacts viscose rayon. A rayon coating is created by passing the treated fiber through a sulfuric acid bath. The resulting composite fiber has the mechanical properties of the core fiber, and the surface properties of rayon. Typically, the rayon skin is not adhered well to the core, particularly if the latter has a smooth surface. Many adhesion promoters have been suggested with varying amounts of success, but the long reaction time required for the acid cure make this method expensive and slow.

Accordingly, there is a need in the art to produce fabrics that have both the positive qualities of cotton and synthetics while eliminating their negative qualities. It is further desirable that the process be fast, economical, and transparent to current textile manufacturing practices, such as sanding, weaving, and dyeing.

### SUMMARY OF THE INVENTION

The present invention is directed to composite fibrous substrates comprising core fibers and a carbohydrate sheath attached around the individual core fibers. The carbohydrate sheath is adhered to itself by covalent bonds.

The present invention is further directed to a method for treating individual synthetic fibers (“core fibers” or “core material”) or yarns or a fabric, garment, woven good, or non-woven good (encompassed herein under the term “substrate” and “fibrous substrate”) made of synthetic fibers, to create a permanently attached carbohydrate sheath around each core fiber of the substrate. Carbohydrates have the desired properties of cotton, which is one type of carbohydrate. Such a treatment gives a substrate that exhibits the most desirable characteristics of the synthetic core coupled with the most desirable characteristics of the natural, carbohydrate sheath. For example, it will exhibit the mechanical properties of a synthetic core fiber and cotton-like surface properties. If desired, it is also possible to apply this technology to individual synthetic, man-made or natural fibers or yarns, before weaving, knitting, stitch-bonding, or other method of woven or non-woven substrate formation.

More particularly, in the process of this invention, an article or substrate that contains synthetic fibers is contacted with an aqueous solution that contains water-soluble carbohydrate polymers or monomers. The carbohydrate monomers/polymers are then crosslinked to each other using a suitable crosslinker to form a durable carbohydrate sheath or encapsulation layer around the synthetic fiber. The resulting treated substrate possesses tactile properties similar to cotton and exhibits hydrophilic properties even after repeated launderings. By comparison, substrates composed of untreated synthetic fibers are typically hydrophobic. One advantage of this method over those of the prior art is the ability to apply it by performing a pad/dry/cure process directly to dyed and finished synthetic fabrics. Also, this process is economical and easily accomplished with currently used textile finishing equipment.

The present invention is further directed to a method of treating a fabric, garment, woven good, or non-woven good (“substrate” or “fibrous substrate”) made of man-made or natural fibers, or individual man-made or natural fibers (“core fibers” or “core material”) or yarns to create a permanently attached carbohydrate sheath or encapsulation layer around the fibers of the substrate. This imparts the desirable properties of a cotton-like surface while retaining some of the functional properties of the core natural or man-made fiber.

According to the present invention, it is possible to incorporate other components into the encapsulation layer to impart durable attributes to the synthetic or natural fiber or fabric. In this way, the carbohydrate layer acts as a binder to encase not only the substrate fiber but also the compound to be incorporated into the outer layer.

### DETAILED DESCRIPTION OF THE INVENTION

As used herein and in the appended claims, “a” and “an” mean “one or more”.

Application of the Sheath Layer

In the preferred embodiment of the invention, the synthetic, man-made, or natural core material in fabric form is passed through a bath containing an aqueous solution of water-soluble carbohydrate and crosslinker and, if necessary, a suitable crosslinker catalyst. This bath is referred to herein as the “carbohydrate polymer sheath formulation” or “sheathing formulation”. The fabric is padded to remove excess liquor, heated to dryness, then cured at a temperature sufficient to cause reaction between the crosslinker and the carbohydrate. Crosslinks are formed between these compounds to form a thin film of carbohydrate on the surface of the core. This layer is referred to herein as a “carbohydrate encapsulation layer”, “carbohydrate sheath”, “sheathing layer” or “sheath”. The same general method can also be applied to individual fibers, ribbons, and shaped materials. Application can also be achieved by spraying, foam, or any other means known in the art for contacting a substrate with a treating solution.

Non-limiting examples of water-soluble carbohydrate polymers include chemically modified cotton, dextran, diethylaminoethyl dextran, dextran sulfate, starch, chitin, chitosan, carboxymethylcellulose (free acid or salt), diethylaminoethyl cellulose, hydroxyethylcellulose, hydroxymethylcellulose, chondroitin-4-sulfate, guarans (guar gums), hydroxypropyl guar, konjac, locust bean gums, xanthan, alginic acid (free acid or salt), carrageenan, and acrylonitrile-grafted starch.

Any compound capable of bonding to two or more nucleophiles (e.g., hydroxyl, amine, thiol, etc.) can be used as a crosslinker to link the hydroxyl groups on the carbohydrate sheath around and/or to the core fiber. One skilled in the art will recognize that many possible crosslinking chemistries, including polycarboxylic acids, aminoplasts (N-methylol), isocyanates, epichlorohydrin, and crosslinkable siloxane polymers, could be employed. Currently preferred crosslinkers are polycarboxylic acids and N-methylol compounds. Polycarboxylic acid crosslinkers include butanetetracarboxylic acid, polymaleic acid, polyacrylic acid, citric acid, etc. Catalysts for use with polycarboxylic acids are known in the art and include sodium hypophosphite. If the molecular weight of the polycarboxylic acid is large (e.g., polyacrylic acid with a MW>10 k), a catalyst is not necessary. N-methylol crosslinkers include those used in permanent press finishes such as dimethylol dihydroxy ethylene urea (DMDHEU), triazone, uron, dimethylol methyl carbamate, trimethylol triazine, dimethylol ethylene urea, and dimethylol urea, as well as polymers that incorporate aminoplast monomers such as N-methylolacrylamide and N-methylolmethacrylamide. These aminoplast species react with nucleophilic groups in the presence of a Lewis acid catalyst, such as magnesium chloride or an aluminum salt.

The present invention is further directed to the synthetic yarns, fibers, fabrics, finished goods, or other textiles (encompassed herein under the terms “textiles”, “fibrous substrates” and “substrates”) treated with the hydrophilic fabric finishes of the invention. These textiles or fibrous substrates will display improved wettability and moisture permeability compared to traditional synthetic and some man-made textiles. In addition, other properties of the fiber may be modified by treatment, such as fiber shininess, fabric feel or “hand”, static dissipation ability, and fiber-fiber abrasion noise characteristics.

The present invention is further directed to a process for treating natural or man-made substrates, such as wool and other keratinaceous fibers, linen, rayon, and the like. Applying a carbohydrate sheath imparts the desirable properties of a cotton-like surface while retaining some of the functional properties of the core natural fiber. For example, wool fabrics have such beneficial properties as heat retention when wet, good drying properties, elasticity, extensibility, drapability and crease-resistance. However, wool is allogenic to a portion of the population, it shrinks and felts upon washing and has a scratchy feel when worn next to the skin. With a cellulosic outer layer according to the present invention, wool can be made shrink-resistant, non-allogenic, aesthetically pleasing, and comfortable while retaining its beneficial properties.

In one embodiment, the process comprises contacting the keratinous fibers with a finish that comprises a combination of polyelectrolyte carbohydrate polymers. Thus, the wool fiber, textile or fibrous substrate is coated with a positively-charged polysaccharide, such as chitosan which contains amines, and is then coated with a negatively-charged polysaccharide, such as alginic acid which contains carboxyl groups. The oppositely charged polymers will form a complex sheathing on the wool fibers to make them less allergenic. The formed complex will be insoluble in organic solvents commonly used in commercial dry-cleaning, such as tetrachloroethylene, thus rendering the coating permanent.

Properties imparted by the carbohydrate sheath or encapsulation layer do not disturb the macro properties of the fabric; that is, the sheath does not significantly increase the diameter of the fibers and does not fill spaces between fibers or clog the fabric with large pieces of sheathing material. Additionally, the treated fabric feels like cotton to the touch, rather than like polyester, and exhibits improved wettability.

The synthetic and natural textiles prepared according to the present invention can be used in a variety of ways including, but not limited to: clothing, upholstery and other home furnishings, hospital and other medical uses, automobile applications, and the like; and industrial uses, such as those listed in Adanur, S., Wellington Sears Handbook of Industrial Textiles, p. 8-11 (Technomic Publishing Co., Lancaster, Pa., 1995).

Garments composed of 100% cotton are generally post-treatment processed in garment form to improve the “shelf” or aesthetic appeal to the consumer. Some properties can be imparted to textile articles by processing in garment form, including a soft hand, shrinkage control, durable press, and unusual and unique appearances, depending on the process used. For example, denim jeans are often wet-processed before sale to improve softness and shrinkage control, and softeners are often used in the final rinse. Lava stones, pumice, bleach, and/or cellulase enzymes can be used to accelerate abrasion and impart a worn look to the garment. These and similar post-treatment processes can be applied to the current invention to improve the aesthetic appeal of the final garment. The carbohydrate sheath encapsulating the synthetic, man-made, or natural fibers allows many of the same post-treatment processing techniques used on cotton to be applied to the treated synthetic, man-made, or natural fabrics of the present invention.

Incorporation of Auxiliary Components Within the Sheathing Layer

The application of a carbohydrate encapsulation layer to a fabric according to the present invention offers the opportunity to simultaneously finish the fabric with auxiliary components that do not have the innate ability to bind durably to the fabric. In this way, the carbohydrate sheathing acts as a binder to impart durability to non-substantive auxiliary components that are co-applied with the sheathing finish. Alternatively, the auxiliary may have substantivity to the carbohydrate finish and can be applied in processing after application of the carbohydrate encapsulation layer. In either method, the base fabric is endowed with a number of properties that cannot be attained without the use of the encapsulation layer.

Some examples of such auxiliary components include infrared-absorbing compounds that can be permanently incorporated onto the fabric to minimize detection from night vision equipment. Examples of infrared-absorbing material are carbon black, chitin resin, or in general, compounds that absorb electromagnetic radiation of wavelengths from 1000 to 1200 nm. Fabric treated with an encapsulating layer containing infrared-absorbing materials accrue infrared absorptive ability as well as other beneficial properties belonging to the encapsulating layer; such fabric may be of particular interest in military applications.

Similarly, ultraviolet light-blocking compounds can be incorporated to protect either the wearer of the garment or the fabric material itself from ultraviolet rays. Colored pigments or dyes may be incorporated in the outer layer to dye the fabric. Magnetic colloids can be embedded in the sheath to provide data storage capabilities to the fabric. Bio-active agents (such as insect repellants, anti-microbials, and pharmaceuticals, for example) may also be incorporated, as well as flame-retardant chemicals and anti-static agents. Odor-absorbing compounds and neutralizers (e.g. activated charcoal or cyclodextrins) or, alternatively, a material that one wishes to release in a prolonged fashion by using, for example, hydrolyzable linkers, may also be applied according to this invention.

In one embodiment, colloids, generically described as particles with a mean diameter between 10 and 500 nanometers, are incorporated into the encapsulating sheath formulation and bound to the treated fabric. Colloid particles are too small to be seen even with conventional microscopy, so the individual particles will not be noticeable on the fabric. However, certain metal colloids such as gold and silver are of particular interest due to their light-absorptive (hence, coloring) properties. Metal colloids absorb light at a maximum absorption wavelength related to metal type and particle size. They have found extensive use in inventions relating to biological and toxicological assays.

U.S. Pat. No. 5,851,777 issued to Hunter et. al. discloses the use of colloidal particles bound to ligands that specifically bind a certain biological or toxicological moiety. Colored metal colloids are specifically claimed as one aspect of the invention. When the specific biological or toxicological moiety is added to a solution containing the ligand-bound metal colloidal particles, ligation to the moiety results in particle aggregation and a shift in the maximum absorption wavelength (i.e. solution color). Hunter et al. also disclose a number of related patents utilizing ligand-bound colloid particles. An important aspect of these inventions is the capacity to bind the ligand to the particle surface via an intermediary polymer. The intermediary polymer is either physically entrained (in part) within the particle or is durably adsorbed to the particle surface. The intermediary polymer of necessity contains reactive groups enabling it to bind to the ligand. The disclosures of U.S. Pat. No. 5,851,777 and those cited therein are incorporated herein by reference.

U.S. Pat. 6,136,044 issued to Todd discloses the use of metal colloids to color substrates such as fibers, yarns and textiles. The substrate to be colored is first placed in a bath containing a reducing agent, preferably an agent that has some substantivity to the substrate. After allowing sufficient time for the reducing agent to adsorb, the substrate is removed from the bath, optionally dried, then placed in a second bath containing a dissolved metal salt corresponding to the metal colloid of interest. The adsorbed reducing agent reduces the salt to the colloid and serves as a nucleating site for particle growth. The resulting particle is adsorbed to the substrate or optionally entangled with the substrate. The substrate is thereby colored with a shade that corresponds to the parameters of metal type, particle size, and amount of metal on the substrate. As each of these parameters can be controlled, a variety of shades can be accessed. The resulting color of the substrate is both wash-fast and light-fast. This method does not require the use of a polymeric binder or other agent to provide colorfastness.

Certain metal colloidal suspensions, specifically silver and copper and more particularly silver, have demonstrated biocidal activity against a broad spectrum of bacterial species. The Merck Index (10^{th} edition) maintains that silver “has been used for purification of drinking water because of toxicity to bacteria and lower forms of life”.

In one embodiment of this aspect of the invention, metal colloids are incorporated into the sheathing formulation to provide coloring to fibrous substrates treated with the formulation. In another embodiment of this aspect of the invention, metal colloids with antimicrobial activity, preferably silver and copper, most preferably silver, are incorporated into the sheathing formulation. Fibrous substrates treated with this formulation are endowed with antimicrobial activity. In another embodiment of this aspect of the invention, metal colloids are incorporated into the sheathing formulation in sufficient amount to facilitate electrical conductivity on the surface of a treated substrate, whereas the untreated substrate has little or no electrical conductivity properties. The treated fibrous substrate thereby receives anti-static properties.

The metal colloids may be incorporated into the sheathing formulation by a variety of methods. In one method, the metal colloids are prepared and then added to the sheathing formulation. The metal colloids may be prepared by reduction of metal salts via chemical, electrochemical or irradiative processes which are known to those of skill in the art. For example, silver salts may be reduced to metallic silver with sodium borohydride (chemical), an electric potential (electrochemical) or with visible light (irradiative). So-called “passivating agents” may be employed in the formation of the metal colloids; these agents may serve as nucleating agents for particle growth and also coat the particle surface to minimize particle aggregation. Common passivating agents include bovine serum albumin, casein, and bovine milk proteins (e.g. powdered milk). Preferably, the passivating agents contain functional groups that react with the components of the sheathing formulations. More preferably, the passivating agents are physically entrained within the colloidal particle to facilitate entrapment of the colloidal particle within the sheath layer.

The metal colloids may also be prepared directly within the sheathing formulation solution or with one or more of the components. A soluble metal salt of the colloid of interest is mixed with between one and all components of the sheathing formulation and then exposed to reductive conditions that induce colloid formation. This approach offers a potential advantage in that a viscous solution of between one and all components of the sheathing formulation can prevent aggregation of the nascent colloidal particles. Furthermore, one or more of the components of the sheathing formulation may function as a passivating agent for the colloid particles.

Incorporation of Colorants:

In another embodiment, colorants can be anchored to the fiber using the current invention as a binder. The term “colorant”, as used herein and the appended claims, refers to either a pigment (water-insoluble) or a dye (water-soluble).

While one of the main aims of a carbohydrate encapsulating finish is to give a “natural-fiber” (e.g., cotton) feel to a synthetic fiber, the treated fiber has quite different chemical and physical properties from a cotton fiber. There are at least three important differences:

First, the material that composes the finish may be only chemically similar, not identical to, a cotton fiber. The chemical differences may have an important effect on the efficacy of various dye classes.

Second, the sheathing layer is highly cross-linked and thus tightly wrapped around the parent fibers. The sheathing layer cannot have significant ability to swell in water; if it did it would not be durable to laundering. Conventional dyeing relies extensively on swelling of the fiber to allow dye adsorption within the fiber; this maximizes both fastness and shade depth. Dyeing a sheath-wrapped fabric with conventional techniques that rely on fiber swelling may be ineffective.

Third, the sheath layer is very thin compared to the thickness of the fiber. Optimal even dyeing throughout the sheath without concomitant dyeing of the core fiber produces only a ring-dyed effect for the entire fiber. Many core fibers have substantivity for only a limited class of dyes, so the ring-dyed effect may be commonly observed when the sheath layer is dyed with a dye without substantivity to the core fiber.

The colorant may be chosen to match the color of the core fiber to give a deeper shade or, alternatively, the colorant could be chosen as a different shade to give a “two-toned” effect. Most likely, although not necessarily, a colorant would be chosen as a dark shade to be placed on top of a lighter-colored core fiber. The effect would be a “ring” dyed fabric. This ring dyeing effect is common to 100% cotton fibers, for example, using vat dyes and indigo for denim. This type of dyeing is not easily performed on synthetic fabric, but is facilitated by the invention described herein. In one embodiment of the invention, the pigment would be dispersed in and co-applied with the encapsulating sheath. Another embodiment of the “two-tone” invention would be to have a separate dyeing step in the processing of the textile. The core fiber (dyed or undyed) would be treated with the carbohydrate outer layer and the fabric subsequently dyed with “cotton” dyes. The dyes would be chosen to react or adhere to the outer surface and not the inner core, or vice versa. For example, a polyester fabric treated with the carbohydrate sheath could be selectively dyed with polyester-specific dyes for the inner core color (or none for white) and dyes specific for carbohydrates to dye the outer layer. Some common dyes for the outer layer include dyes that will either: a) physically absorb (direct dyes), b) be mechanically retained (vat dyes and sulfur dyes), or c) be chemically reacted (reactive dyes) to the carbohydrate surface. This technique provides a way to make numerous effects and colors. Frosted (lighter color on top of darker), two-tone (two different colors), and “distressed” (outer layer can be selectively abraded or hydrolyzed to get a worn look) effects are all possible via the present invention.

Methods of Coloring:

As used herein, the terms “one-step method” and “multiple-step method” refer to the number of steps required to process the fabric or fibrous substrate that is to receive a colored sheathing layer. The “one-step” method may require several steps prior to involvement of the substrate, but the colorant and sheath are applied to the fabric simultaneously. In a multi-step method, the colorant and sheath are applied in separate steps.

One-Step method: The most facile process is incorporation of the colorant into the base carbohydrate sheathing formulation prior to application of the finish to fabric. The colored formulation is then applied according to conventional methods such as immersion, spray, or padding, wherein the latter method is preferred. The colorant may be held within the sheath by such means as physical entanglement or encapsulation, electrostatic coordination, or chemical bonding to the sheathing material. Aside from simplicity of processing, another advantage this method provides is in attainable depths of shade. The sheathing layer is at most ten-fold less thick than the fabric fiber it encapsulates and is probably even smaller. Distributing the colorant evenly throughout the sheathing layer maximizes the amount of colorant applied. Even distribution also helps ensure that the colorant is “colorfast” or not easily removed by washing or other abrasive conditions. Potential disadvantages may include lack of equipment and/or reluctance within textile mills to apply colorant during the finishing process, difficulty in achieving even application and depth of shade in the padding process as well as cleanup and disposal problems for a colored sheathing finish.

Multiple-Step method: In this method, the colorant is applied to fabric that has previously been finished with a base carbohydrate sheathing formulation. The applied formulation may optionally include a component that has a particular affinity for the colorant. Alternatively, the finished fabric may optionally be treated with a component with affinity to both the sheathing layer and the colorant prior to exposure to the colorant. A potential advantage of this method is the use of colorants that cannot be mixed into the sheathing formulation without altering the stability or durability of the sheath. Another advantage may be access to distinct aesthetic effects in comparison to the one-step method. Disadvantages include limitations on the types of effective colorants as well as probable surface accumulation of colorant with corollary problems of poor shade depth, crockfastness, and colorfastness. The sheathing layer is tightly cross-linked, which may prevent the colorant from penetrating the layer to any significant depth.

Some specific descriptions of approaches to coloration with known dye classes are hereafter described. One or both of the methods described above may be applicable in these approaches.

Mordant Fixation: Certain metal species, called mordants, form strong bonds to chemical reactive groups such as carboxylate and phenol functionalities; the resulting mordant complexes do not dissociate in water and are often water-insoluble. As the mordant-reactive chemical groups are found on many types of dyes, mordant complexation provides a means of affixing an insoluble dye on or within a substance, particularly when the substance also complexes with the mordant metal. Mordant metals include chromium, cobalt, nickel, aluminum and zirconium.

In a one-step embodiment, the mordant and mordant-reactive dye are mixed into a base carbohydrate sheathing formulation. The mordant and mordant reactive dye are mixed into the formulation in an amount, order and manner that facilitate desired properties of the resulting colored formulation. Preferably, the resulting formulation is stable, e.g. the mordant complexes do not precipitate out. Stability is facilitated by mordant coordination to reactive groups on the water-soluble polymers of the base sheathing formulation. However, if the base sheathing formulation is sufficiently viscous, the mordant complexes may be adequately suspended within the formulation and water solubility may not be required. The mordant should be added in any amount desired up to the level where aggregation within the base sheathing formulation produces instability. The dye is added as desired up to an amount which fully utilizes the binding capacity of the added amount of mordant. The colored sheathing formulation is then applied to the fibrous substrate and the treated substrate is cured to affix the sheathing layer in place. The dye is bound durably within the sheathing layer by mordant complexation as well as by physical encapsulation.

In a multi-step embodiment, the mordant is mixed into a base carbohydrate sheathing formulation in an amount and manner that facilitate desired properties of the resulting mordant-modified formulation. Preferably, the mordant forms bonds to the sheathing material, but in any case the resulting formulation is stable, e.g. the mordant complexes do not precipitate out. Stability is facilitated by mordant coordination to reactive groups on the water-soluble polymers of the base sheathing formulation. However, if the base sheathing formulation is sufficiently viscous, the mordant complexes may be adequately suspended within the formulation and water solubility may not be required. The mordant should be added in any amount desired up to the level where aggregation within the base sheathing formulation produces instability. The mordant-modified formulation is then applied to the fibrous substrate and the treated substrate is cured to affix the sheathing layer in place. The sheath-wrapped fibrous substrate is then exposed to a mordant-reactive dye by techniques known to those of skill in the art. In a preferred method, the fibrous substrate is exposed to a solution containing the dye at temperatures and for time periods that facilitate the reactive group(s) on the dye to complex with the mordant metals bound into the sheath. The dyed fibrous substrate is then dried. The dye is durably bound to the sheath layer by mordant complexation, but it is believed that the dye will only bind on the outer layer of the sheath layer due to the tight cross-linking within the sheath.

In another multi-step embodiment, sheath-wrapped fibrous substrate is exposed to mordant-metal solution. The mordant metal is exhausted onto the substrate by complexation with exposed reactive groups of the sheath material. The mordant-treated fibrous substrate is then removed from the solution, optionally dried, and then exposed to a solution containing a mordant-reactive dye. The dye is exhausted onto the sheath layer via complexation with the mordant on the sheath surface.

Other embodiments of this dyeing method are easily recognizable; although not described, all such embodiments are considered to be within the scope of the invention.

Pigments, Vat dyes, and Sulfur Dyes: Vat and sulfur dyes are hybrids between dyes and pigments; they are used to dye cotton and other cellulose-based fibers. In their chemically reduced (“leuco”) forms they are water-soluble dyes, but when oxidized they become insoluble pigments. In conventional fiber dyeing, the fibers are exposed to the dyes in reduced form, which facilitates penetration of the dyes into the fiber. The fibers are then exposed to oxidating conditions, which induce the formation of insoluble particles adsorbed within the fibers. This hybrid behavior provides a variety of methods in which these dyes may be used as colorants in the sheathing formulation.

In a one-step method, a pigment or oxidized vat or sulfur dye is dispersed into a carbohydrate sheathing formulation. Optionally, a surfactant may be included to aid in the dispersion. A viscous base sheathing formulation is also helpful in aiding dispersion lifetime by slowing the rate of settling. The colorant may be added as a solid powder or as an aqueous dispersion. In both cases but particularly the latter it is desirable that the addition of colorant not dilute the sheathing formulation to the extent that the sheath loses durability or does not effectively provide its properties when applied to the fibrous substrate. Aqueous dispersions of pigments are available from BASF under the trade-name of HiFast™. The colored sheathing formulation is then applied to the substrate and cured in place. The colorant is dispersed throughout the sheathing layer and is held in place by physical encapsulation.

In another one-step method, a leuco vat or sulfur dye solution is added to the sheathing formulation and the combined formulation is then oxidized to form a dispersion of colorant within the sheathing formulation. Optionally, the pH of the colored sheathing formulation may need to be adjusted within the specifications required for the base sheathing formulation. This method provides for partial encapsulation of the sheathing polymer material within the oxidized particles. As above, a viscous base sheathing formulation is helpful in aiding dispersion lifetime by slowing the rate of particle settling. The resultant dispersion is then applied to a fibrous substrate, which is then cured to affix the sheathing layer. The encapsulated colorants are held fast by physical entanglements.

In another one-step method, one or more of the sheathing material components are added to a solution of a leuco, vat or sulfur dye. Preferably the component(s) are added in an amount equivalent to their weight percentage in the base sheathing formulation. More preferably, the addition of the components significantly increases the viscosity of the solution. The leuco dye is then oxidized to form a dispersion of particles, preferably partially encapsulating the sheathing material component(s). If required, the remaining components of the base sheathing formulation are added and the pH is adjusted to the required specification for cross-linking. The colored formulation is then applied to a fibrous substrate, and the substrate is cured to affix the sheathing layer. The encapsulated colorants are held fast by physical entanglements.

Other embodiments of this dyeing method are easily recognizable; although not described, all such embodiments are considered to be within the scope of the invention.

Modified Reactive Dyeing: Commercially available reactive dyes are typically used to dye cotton and cellulose-derived fibers. They contain functional groups that react with nucleophilic sites under conditions of highly alkaline pH and elevated temperature. They are extremely colorfast, as the dye becomes covalently bound to the fiber. In the present invention, the sheathing material may not include appropriate reactive sites or may not be applied at highly alkaline pH; either case prevents reaction with commercial reactive dyes. Another challenge in the use of reactive dyes is hydrolysis of the reactive sites; hydrolysis competes with the cellulosic hydroxyl groups for reactivity of the dye and leads to inefficient dye use.

A variety of approaches may be employed to circumvent the difficulties described above. In one approach, the dye is first modified by reaction with a bifunctional reagent; one functional group of the reagent reacts with the dye and the other binds to the sheathing material. The modified dye is then added to a base carbohydrate sheathing formulation that can then be applied to a fibrous substrate in a one-step method. In another approach, a bifunctional reagent is added to a base sheathing formulation. The bifunctional reagent has one functional group that reacts preferentially with a reactive dye, the other binds to the sheathing material. The modified sheathing formulation is applied to the substrate and cured to affix the sheathing layer and bind the reagent. The treated substrate is then dyed with a reactive dye in a multiple-step method, wherein the reactive dye reacts preferentially with the remaining functional group of the reagent. In yet another approach, the sheathing formulation incorporates one bifunctional reagent and the reactive dye is modified with a second bifunctional reagent. The two reagents each contain at least one functional group which reacts preferentially with a functional group of the other reagent. Either a one-step or multiple-step application may be envisioned in this case. Similar ideas have been presented by Lewis and Vigo (Lewis, D. M., Lei, X.; AATCC International Conference and Exhibition Book of Papers, Oct 4-7, 1992, pp. 259-265; Vigo, T. L., Blanchard, E. J.; AATCC International Conference and Exhibition Book of Papers, 1996, pp. 203-208; Vigo, T. L., Blanchard, E. J.; Textile Chemist and Colorist, vol. 19, No. 6 (1987); U.S. Pat. No. 4,678,473); however in these cases a cellulosic fiber is modified rather than a sheathing layer.

Examples of functional groups that react preferentially with reactive dyes include amines and thiols; these groups are much better nucleophiles than water and can eliminate wasteful hydrolysis. Amines are more preferred. Examples of functional groups that can react with components of a carbohydrate sheathing layer include, but are not limited to, hydroxyls, amines, thiols, amido-formaldehyde condensates, five- and six-membered ring cyclic anhydrides, dicarboxylates capable of forming five- and six-membered ring cyclic anhydrides, and blocked isocyanates. Non-limiting examples of bifunctional reagents include ethylene diamine, ethanolamine, and aspartic acid.

It has also been discovered that mixing dyes with either a carboxylic acid functionality or a 1,2-dihydroxyquinone structure into a sheathing formulation provides a colorant formulation that imparts washfast and crockfast color to fibrous substrates treated with the formulation. Dyes without these functional groups are not washfast or crockfast. Examples of dyes with carboxylic acid groups include methyl red, mordant yellow 12 and mordant orange 1. Examples of dyes with a 1,2-dihydroxyquinone structure include alizarin and purpurin. Without being limited to theory it is believed that the carboxylic acid groups react with nucleophilic moieties of the sheathing material and that the hydroxyls of the 1,2-dihydroxyquinone react with electrophilic moieties of the sheathing material. A preferred nucleophilic moiety is a hydroxyl group; a preferred electrophilic moiety is a carboxylic acid group. The dyes are held within the sheath by covalent bonds and so the dye is behaving according to the classification of a “reactive” dye,

Other embodiments of this dyeing method are easily recognizable; although not described, all such are considered to be within the scope of the invention.

### EXAMPLES

Experimental Measurements:

Wet Times: All wet times are the average of six measurements. All numbers given are the time needed for a drop of distilled water placed on the sample to be fully absorbed. All times greater than 120 sec were recorded and averaged as 120 sec. During measuring, all samples were elevated so that neither the upper nor the lower surface of the sample was touching a solid surface.

Percent Add-on: The percent add-on to the fabric after washing was determined by weight difference before and after acid digestion. Four-inch by four-inch samples were used in the following steps:

1. The samples were dried on an aluminum pan of known weight. For drying, the samples were kept at 100-110° C. for 1 hour. The samples were cooled for 10 min. in a dessicator. Each pan with sample was then weighed.

2. The samples were placed in 200 g of a 70 wt % H₂SO₄ solution for 45 minutes. The samples were kept at 70° C., in a shaking incubator.

3. The samples were rinsed twice with 250-300 mL of warm tap water, and twice with room temperature distilled water.

4. Samples were dried and weighed as in step one.

The “percent add-on” is the weight difference between the measurements of steps 1 and 4, divided by the dry cloth weight of step 1, times 100. The percent cellulose of the untreated control was subtracted from all samples to normalize the untreated control. Two samples were measured for each treatment and the measurements averaged to arrive at the final percent cellulose.

### Example 1

A. Formulation:

An aqueous solution was made of the following: 7 wt % ultra low viscosity carboxymethylcellulose Na salt (degree of substitution 0.7; Aldrich Chemical Co., Milwaukee, Wis.), 25 wt % Freerez NFR (BFGoodrich, Charlotte, N.C.), 5 wt % Freecat 9 (BFGoodrich), and 0.5 wt % Ethox DA-9 (Ethox Chemicals, Greenville, S.C.). The final pH was 3.47.

B. Application:

Sanded, tan Burlington Industries' (Greensboro, N.C.) style 2606 polyester was dipped in the above solution and padded to 93% wet pick up, dried 5 min. at 250° F., and cured 30 sec at 390° F. The treated samples were then tested as described hereinabove.

C. Results:

| Wet times: | 1 HL: | 2.8 sec |
|---|---|---|
| | 10 HL: | 12.0 sec |
| | 20 HL: | 20.7 sec |
| Wt % Add-on: | 1 HL: | 5.5% |
| | 20 HL: | 4.7% |

### Example 2

A. Formulation:

An aqueous solution was prepared using 7 wt % ultra low viscosity carboxymethyl cellulose Na salt (degree of substitution 0.7; Aldrich Chemical Co.), 6 wt % BTCA (1,2,3,4-butanetetracarboxylic acid, Aldrich Chemical Co.), 4 wt % sodium hypophosphite monohydrate (Atlas Chemical, Inc., San Diego, Calif.), and 0.5 wt % Ethox DA-9 (Ethox Chemicals). The final pH was 3.30.

B. Application:

Sanded, tan Burlington Industries' style 2606 polyester was dipped in the above solution and padded to 85% wet pick up, dried 5 min at 250° F., and cured 30 sec at 390° F. The treated samples were then tested as described hereinabove.

C. Results:

| Wet times: | 1 HL: | 3.7 sec |
|---|---|---|
| | 10 HL: | 6.0 sec |
| | 20 HL: | 5.3 sec |
| Wt % Add-on: | 1 HL: | 7.6% |
| | 20 HL: | 4.8% |

### Example 3

A. Formulation:

An aqueous solution was prepared using 7 wt % ultra low viscosity carboxymethyl cellulose Na salt (degree of substitution 0.7; Aldrich Chemical Co.), 4 wt % 75,000 MW poly(acrylic acid) (Aldrich Chemical Co.), and 0.5 wt % Ethox DA-9 (Ethox Chemicals). The final pH was 3.31.

B. Application:

Sanded, navy Burlington Industries' style 2606 polyester was dipped in the above solution and padded to 85% wet pick up, dried 5 min at 250° F., and cured 30 s at 390° F. The treated samples were then tested as described hereinabove.

C. Results:

| | | |
|---|---|---|
| Wet times: | 1 HL: | 0.5 sec |
| | 5 HL: | 0 sec |
| | 10 HL: | 0 sec |
| | 15 HL: | 0.8 sec |
| | 20 HL: | 1.5 sec |

### Example 4

A. Formulation:

An aqueous solution was prepared using 7 wt % ultra low viscosity carboxymethyl cellulose Na salt (degree of substitution 0.7; Aldrich Chemical Co.), 4 wt % 75,000 MW poly(acrylic acid) (Aldrich Chemical Co.), and 0.5 wt % Ethox DA-9 (Ethox Chemicals). The final pH was 4.51 and the viscosity was 556 cP.

B. Application:

Sanded, navy Burlington Industries' style 2606 polyester was dipped in the above solution and padded to 69% wet pick up, dried 5 min at 250° F., and cured 30 s at 390° F. The treated samples were then tested as described hereinabove.

C. Results:

| | | |
|---|---|---|
| Wet times: | 1 HL: | 4.0 sec |
| | 5 HL: | 5.3 sec |
| | 10 HL: | 6.0 sec |
| | 15 HL: | 6.0 sec |
| | 20 HL: | 6.3 sec |

### Example 5

An aqueous solution was prepared using 4 wt % ultra low viscosity carboxymethyl cellulose Na salt (degree of substitution 0.7; Aldrich Chemical Co.), 5 wt % poly(acrylic acid) (MW=100,000-125,000; Aldrich Chemical Co.), 0.1 wt % WetAid NRW wetting agent (BFGoodrich, Charlotte, N.C.), and 0.05 wt % Kathon CG-ICP preservative (Rohm and Haas, La Porte, Tex.). The final pH was 3.8.

### Example 6

An aqueous solution was prepared using 4 wt % carboxymethyl cellulose (Aqualon 7L2; Aqualon, subsidiary of Hercules Chemical Co.), 5 wt % poly(acrylic acid) (MW=100,000-125,000; Polacryl), 0.1 wt % WetAid NRW wetting agent (BFGoodrich, Charlotte, N.C.), and 0.05 wt % Kathon CG-ICP preservative (Rohm and Haas, La Porte, Tex.). The final pH was 3.8.

This formulation was mixed individually with four different pigments in the ratio of 99% solution and 1% pigment wt/wt basis. The formulation was thoroughly blended by homogenizing while adding the pigment to the solution. The four pigments used were HiFast Golden Yellow, HiFast Red, and S Black (BASF, Charlotte, N.C.) and Indigo paste 42% liquid (Buffalo Color Corp., Parsippany, N.J.). The colored formulations were then padded onto 12″×15″ swatches of sanded, woven, undyed microfiber polyester from Burlington Industries (style 2606). As comparison, the solution without colorant was also padded onto a swatch. The swatches were dried at 190° F. for five minutes, then cured at a fabric temperature between 322 and 335° F. for thirty seconds. The swatches are, respectively, medium shades of yellow, red, charcoal gray, blue, and white. Each swatch was cut into six test samples which were laundered 0,1, 5, 10, 20, or 30 times according to AATCC method 143 (normal/cotton sturdy). Visual evaluation of color on each sample shows that there is a slight shade change or lightening after the first laundering, and perhaps extremely slight shade changes between one and five launderings. After five home launderings the shade appears to remain equal between launderings. The hand of the colored samples is identical to that of the sample without colorant. This indicates that the sheathing layer is an effective binder for pigments.

### Example 7

Woven, sanded microfiber polyester was treated with the aqueous solution of Example 6 and then dried and cured at a fabric temperature of 350° F. for thirty seconds. The treated polyester was then placed into a jet dying machine in a 100° F. bath adjusted to pH to 5.5 with acetic acid. After ten minutes, a 3% owf addition of Sandene 8425 (a polyethyleneamine dye fixative, Clariant Corp.) was placed in the bath, which was then heated to 160° F. over 15 minutes. Sufficient sodium carbonate was added to raise the pH to 9.5 over fifty minutes, then the bath was held at temperature for an additional fifteen minutes. The bath was then cooled to 100° F. and the substrate rinsed with cold water for ten minutes.

The bath was then heated to 100° F. and the following components were added: sodium sulfate and Sedgebuf N (1 g/L, Omnova Chemical), Sedgekil 832 (1 mL/L, defoamer from Omnova Chemical), and Solophenyl Navy BLE 250% (CibaSC). The salt concentration and pH were determined; pH should be 5.5 to 6.0. The bath was heated to 180° F. at 6°/minute, then ramped up to 250° F. at 2°/minute. The bath is held at temperature for 30 minutes, then cooled to 140° F. The bath was dropped and refilled with water at 100° F.; after five minutes the bath was again dropped and refilled at 100° F. Sodium sulfate (7.5% owf), acetic acid (0.3% owf) and Burcofix 195 (4% owf, Burlington Chemical Company) were added to the bath. The bath was then heated to 140° F. at 2°/minute, then held at temperature for fifteen minutes after which the fabric was unloaded and dried. The resulting fabric has a dark navy shade. A comparative substrate dyeing treatment of the substrate without the Sandene 8425 application process produced fabric of only a light blue color; that is, the dyed fabric was not washfast.

The following direct dyes were also applied to polyester using the procedure described above, but replacing Solophenyl Navy BLE: Burco Rubine BL200% (Burlington Chemical), Optisol Green BL, Indosol Yellow SF-2RL, Pyrazol Orange LUF, Lumicrease Grey 3LBN 200, Optisol Royal Blue 3RL, Pyrazol Turq FBL 400% (all from Clariant Corp.), and Intrasil Black XTR (Yorkshire). All of these dyes dyed the fabric to deep shades of the corresponding color. A comparative substrate dyeing treatment of the substrate without first applying Sandene 8425 produced dyed fabric without washfastness.

### Example 8

Woven, sanded microfiber polyester was treated with the aqueous solution of Example 6 and then dried and cured at a fabric temperature of 350° F. for thirty seconds. The treated polyester was then placed in a bath adjusted to pH 5.5 with acetic acid. A 3% owf addition of Sandene 8425 (a polyethyleneamine dye fixative, Clariant Corp.) was placed in the bath, which was then heated to 70° C. over 15 minutes. Sufficient sodium carbonate was added to raise the pH to 9.5, and the bath was held at 70° C. for 15 minutes. The bath was then cooled to room temperature and the substrate rinsed with cold water. The substrate was then dyed with a reactive dye at low salt concentrations and neutral pH. The fibrous substrate dyed a deep shade that was washfast without further treatment. A comparative substrate dyeing treatment of the substrate without first applying Sandene 8425 produced fabric without washfastness.

### Example 9

Five solutions were prepared by combining 100.09 portions of the aqueous solution of example 6 with 0.5 g of each of the following dyes: alizarin, purpurin, methyl red, mordant orange 12, mordant yellow 1. Swatches of sanded microfiber polyester from Burlington Industries (style 2606, 12″×12″) were padded in each formulation and then dried and cured as described in Example 6. The colored samples were each cut into four 6″×6″ swatches that were laundered 0, 1, 20, or 30 times according to AATCC method 124-1996 1 (A). The colorfastness of each dye was evaluated qualitatively by visual inspection. The swatches were evaluated for crockfastness by AATCC method 8-1996. Wet times were observed as described above. Results are recorded in the table below. In general, a quite modest drop-off in shade occurs between 0 and 1 launderings, and very little shade change occurs after that. Crockfastness at 0 and 1 HL is typically 4.0 or better.

Table for Example 9

| | Dye | | | | |
|---|---|---|---|---|---|
| | | | Methyl | Mordant | Mordant |
| | Alizarin | Purpurin | Red | Orange 1 | Yellow 12 |
| Shade @ 0 HL | Orangish- | Peachy- | Pinkish- | Tannish- | Light |
| | yellow | Orange | Orange | light | Yellow |
| | | | | yellow | |
| Shade @ 1 HL | Orangish- | Peachy- | Orange | Light | Light |
| | Tan | Orange | | yellow | Yellow |
| Shade @ | Orangish- | Peachy- | Orange | Light | Light |
| 20 HL | yellow | Orange | | yellow | Yellow |
| Shade @ | Orangish- | Peachy- | Orange | Light | Light |
| 30 HL | yellow | Orange | | yellow | Yellow |
| Dry Crock @ | 5.0 | 4.0 | 4.0 | 4.0 | 4.5 |
| 0 HL | | | | | |
| Dry Crock @ | 5.0 | 4.0 | 5.0 | 5.0 | 4.5 |
| 1 HL | | | | | |
| Dry Crock @ | 5.0 | 5.0 | 5.0 | 5.0 | 5.0 |
| 20 HL | | | | | |
| Wet Time (s) | 25.8 | 31.3 | 31.8 | 27.7 | 27.5 |
| @ 0 HL | | | | | |
| Wet Time (s) | 3.5 | 2.3 | 4.8 | 5.7 | 4.5 |
| @ 1 HL | | | | | |
| Wet Time (s) | 3.0 | 4.7 | 4.0 | 2.8 | 3.8 |
| @ 20 HL | | | | | |
| Wet Time (s) | 5.3 | 14.2 | 4.2 | 10.0 | 8.3 |
| @ 30 HL | | | | | |

### Example 10

An individual fiber from a polyester fabric treated with carboxymethylcellulose according to the present invention (Example 6, formulation prior to addition of colorant) was viewed by scanning electron microscopy (5000×). The cellulosic sheath formed around the hydrophobic fiber was too thin to be detected on the scanning electron micrograph. Thus, properties imparted by the sheath do not disturb the macro properties of the fabric; that is, the sheath does not significantly increase the diameter of the fibers, it does not fill spaces between fibers or clog the fabric with large pieces of cellulosics, and the like. Additionally, the treated fabric feels like cotton to the touch, rather than like polyester, and exhibits improved wettability.

### Example 11

### Incorporation of Auxiliaries Into Sheath Layer: UV Protection

Formulation: An aqueous solution was prepared using 4 wt % carboxymethyl cellulose (Aqualon 7L2; Aqualon, subsidiary of Hercules Chemical Co.), 5 wt % poly(acrylic acid) (MW=100,000-125,000; Polacryl), 0.1 wt % WetAid NRW wetting agent (BFGoodrich, Charlotte, N.C.), 0.05 wt % Kathon CG-ICP preservative (Rohm and Haas, La Porte, Tex.), and 6 wt % titanium dioxide particles. Four titanium dioxide particles with distinct particle size were used in the evaluation. Tronox CR-826 (average particle size 200 nm), Tronox CR-800 (average particle size 190 nm) both from Kerr-McGee Chemical, LLC., Oklahoma City, Okla., and UV-Titan L530 and L181 at 30 nm and 17 nm particle size, respectively, from Kemira Chemicals Canada Inc., Maitland, Ontario.

Woven, black, 100% polyester fabric was dipped into each solution, padded and dried at 195F for 5 minutes and cured at 335F for thirty seconds. Durability to at least 25 home laundering cycles (limit of testing) was determined for the Tronox samples by visual observation of the white pigmented particles. Durability laundering for the UV-Titan samples was determined by wet times as previously described. The UV-Titan particles are coated with a polyalcohol, giving fabric treated with it enhanced hydrophilic character compared to the same treatment without the UV-Titan particles (see wet times in the table below):

Table for Example 11: Wet times.

| Sample | 10 HL | 25 HL | |
|---|---|---|---|
| UV-Titan L181 | 0.3 sec. | 1.0 | sec. |
| UV-Titan L530 | 1.8 sec. | 5.5 | sec. |
| No UV-Titan | 7.7 sec. | 12.0 | sec. |

### Example 12

### Incorporation of Auxiliaries Into Sheath Layer: Activated Carbon

A formulation similar to Example 10 was prepared, substituting activated carbon powder (8% by weight) in place of the titanium dioxide. The carbon was purchased from Fluka Chemical (Milwaukee, Wis.) with particle size approximately 40 μm. Woven, white, 100% polyester fabric was treated with the solution and dried and cured as in Example 10. Visual observation at 25 home laundering indicated that the carbon (black) is attached to the fabric.

### Example 13

### Incorporation of Auxiliaries Into Sheath Layer: Antistatic Components

An aqueous solution was prepared using 4 wt % carboxymethyl cellulose (Aqualon 7L2; Aqualon, subsidiary of Hercules Chemical Co.), 5 wt % poly(acrylic acid) (MW=100,000-125,000; Polacryl), 0.1 wt % WetAid NRW wetting agent (BFGoodrich, Charlotte, N.C.), 0.05 wt % Kathon CGICP preservative (Rohm and Haas, La Porte, Tex.), and an antistatic component. Antistatic components used were: Di(polyoxyethylene)hydroxymethyl phosphonate, purchased from Akzo Nobel Chemicals Inc. (Dobbs Ferry, N.Y.) and sold as Victastab™ HMP, and (3-chloro-2-hydroxypropyl)trimethyl ammonium chloride, purchased from Aldrich Chemical (St. Louis, Mo.). The additives were included separately at 5% by weight. Undyed, 100% polyester woven fabric was dipped into the above solutions, padded to approximately 70% wet pick-up, dried, and cured at 335° F. for 30 seconds. The resistance to static charge generation was measured using the AATCC (American Association of Textile Chemists and Colorists) Test Method 115-2000 “Electrostatic Clinging of Fabrics: Fabric to Metal Test” after repeated home laundering. These samples were compared to an untreated piece of polyester fabric and a piece of untreated woven 100% cotton fabric (see table below). In the test method, the time is measured for the charge on a fabric specimen to decay to a level where the electrical attractive forces between the specimen and the metal plate are reduced such that the fabric falls by gravity away from the plate. Samples were tested at 35% relative humidity and 70° F.

Table for Example 13:
Time in minutes for fabric to
separate from metal sheet.

| Sample/Additive | 1 HL | 5 HL | 10 HL | 25 HL |
|---|---|---|---|---|
| Polyester/none | 9.5 | >10 | >10 | >10 |
| Cotton/none | 3.0 | 1.7 | 1.7 | 1.7 |
| Polyester/Victstab HMP | 1.2 | 0.9 | 3.2 | >10 |
| Polyester/(3-chloro-2- | 0.0 | 0.0 | 2.6 | >10 |
| hydroxypropyl)trimethyl | | | | |
| ammonium chloride | | | | |

What is claimed is:

1. A composite fibrous substrate comprising core fibers and a carbohydrate sheath attached around the individual core fibers and wherein the carbohydrate sheath is adhered to itself by covalent bonds.

2. A composite fibrous substrate according to claim 1 wherein the carbohydrate sheath further comprises at least one auxiliary component.

3. A composite fibrous substrate according to claim 2 wherein the auxiliary component is selected from the group consisting of metal colloids, magnetic colloids, infrared-absorbing compounds, ultraviolet light-blocking compounds, bioactive agents, flame-retardant chemicals, antistatic agents, odor-absorbing compounds, neutralizers, and hydrolyzable linkers.

4. A composite fibrous substrate according to claim 2 wherein the auxiliary component is a colorant.

5. A composite fibrous substrate according to claim 1 wherein the core fibers are selected from the group consisting of synthetic fibers, man-made fibers, and natural fibers.

6. A method of preparing a composite fibrous substrate, the method comprising the steps of:
contacting a fibrous substrate comprising core fibers with an aqueous solution of water-soluble carbohydrate and a crosslinker and, optionally, a suitable crosslinker catalyst;
heating the fibrous substrate to dryness; and
curing at a temperature sufficient to cause reaction between the crosslinker and the carbohydrate;
to give a composite fibrous substrate comprising a carbohydrate sheath attached around the individual core fibers of the substrate and wherein the carbohydrate sheath is adhered to itself by covalent bonds.

7. A method according to claim 6 wherein the aqueous solution further comprises at least one auxiliary component.

8. A method according to claim 7 wherein the auxiliary component is selected from the group consisting of colorants, metal colloids, magnetic colloids, infrared-absorbing compounds, ultraviolet light-blocking compounds, bioactive agents, flame-retardant chemicals, anti-static agents, odor-absorbing compounds, neutralizers, and hydrolyzable linkers.

9. A method according to claim 6 which further comprises the step of reacting the carbohydrate sheath with at least one auxiliary component to bind the auxiliary component onto or within the carbohydrate sheath.

10. A method according to claim 9 wherein the auxiliary component is selected from the group consisting of metal colloids, magnetic colloids, infrared-absorbing compounds, ultraviolet light-blocking compounds, bioactive agents, flame-retardant chemicals, anti-static agents, odor-absorbing compounds, neutralizers, and hydrolyzable linkers.

11. A method according to claim 9 wherein the auxiliary component is a colorant.

12. A method according to claim 6 which further comprises the step of treating the composite fibrous substrate with a post-processing treatment generally used on cotton.

13. A method of dyeing a composite fibrous substrate, the method comprising preparing a composite fibrous substrate according to claim 6; and reacting the carbohydrate sheath with at least one colorant to bind the colorant onto or within the carbohydrate sheath; to give a dyed composite fibrous substrate having the colorant on or in the carbohydrate sheath.

14. A method according to claim 13 which further comprises the steps of:
contacting the dyed composite fibrous substrate with an aqueous solution of water-soluble carbohydrate and a crosslinker and, optionally, a suitable crosslinker catalyst;
heating the dyed fibrous substrate to dryness; and
curing at a temperature sufficient to cause reaction between the crosslinker and carbohydrate.

15. A method according to claim 13 wherein the colorant is lighter than the color of the core fibers of the fibrous substrate.

16. A method according to claim 13 wherein the colorant is darker than the color of the core fibers of the fibrous substrate.

17. A method of dyeing a composite fibrous substrate, the method comprising:
contacting a fibrous substrate comprising core fibers with an aqueous solution of water-soluble carbohydrate, a crosslinker, a colorant and, optionally, a suitable crosslinker catalyst;
heating the fibrous substrate to dryness; and
curing at a temperature sufficient to cause reaction between the crosslinker and the carbohydrate;
to give a dyed composite fibrous substrate comprising a carbohydrate sheath attached around the individual core fibers of the substrate and wherein the carbohydrate sheath is adhered to itself by covalent bonds and wherein the colorant is within the carbohydrate sheath.

18. A method according to claim 17 which further comprises the steps of:
contacting the dyed composite fibrous substrate with an aqueous solution of water-soluble carbohydrate and a crosslinker and, optionally, a suitable crosslinker catalyst;
heating the dyed fibrous substrate to dryness; and
curing at a temperature sufficient to cause reaction between the crosslinker and carbohydrate.

19. A method according to claim 17 wherein the colorant is lighter than the color of the core fibers of the fibrous substrate.

20. A method according to claim 17 wherein the colorant is darker than the color of the core fibers of the fibrous substrate.
